(19) United States
(12) Patent Application Publication
(10) Pub. No.: US 2016/0290315 A1
(43) Pub. Date: Oct. 6, 2016

(54) WIND POWER GENERATION SYSTEM

(71) Applicant: James Michael BORLE, RIDDELLS CREEK (AU)

(72) Inventor: James Michael BORLE, RIDDELLS CREEK (AU)

(21) Appl. No.: 15/035,399

(22) PCT Filed: Nov. 6, 2014
(86) PCT No.: PCT/AU2014/050336

§ 371 Date: May 9, 2016

(30) Foreign Application Priority Data
Nov. 8, 2013 (AU) 2013904326

(51) Int. Cl. F03D 3/04; F03D 9/00; F03D 13/20; F03D 3/00

(52) U.S. Cl. CPC F03D 3/04; F03D 3/002; F03D 9/002; F03D 13/20; F05B 2240/9112

(57) ABSTRACT

A system for generating electrical energy. The system includes: a wind turbine mounted in a position proximal to one or more structures. The mounting position is such that the one or more structures act to channel wind toward the turbine. The system is applicable to smaller scale power production such as domestic and light industrial settings.

### FIELD OF THE INVENTION

The present invention relates generally to the generation of electrical energy from the wind. In particular, the invention relates to generation at the micro power level.

### BACKGROUND TO THE INVENTION

Wind power has now developed to the point where it is a mainstream method of generating electricity. Existing means include large scale wind farms which can supply entire communities. These wind farms are exclusively in “open field” sites where access to wind is unimpeded by buildings, trees or geographical features. Such installations include propeller-type horizontal-axis wind turbines mounted on towers of significant height to optimise wind access and therefore power generation.

Means for generating wind power at smaller scales (1 to 100 kW are also known. Such installations may be used to augment the power supply of a home or a business. The basic components and operation of a horizontal axis small wind electric system with a multi-phase permanent magnet alternator is as follows. The turbine rotates on a vertical axis (the yaw axis) and faces the rotor with blades square-on into the wind direction. The rotor itself rotates on a horizontal axis through aerodynamic forces. There are two types of aerodynamic forces—lift and drag. It is the lift effect that causes the blades to rotate. When the blades are turning, this mechanical energy is converted into electrical energy using an alternator, which produces alternating current (AC) electricity. Copper or aluminum coils attached to the rotor through a shaft rotates in a magnetic field generated by fixed permanent magnets. A bridge rectifier, which can be contained within or on the outside of the generator housing converts AC electricity to direct current (DC).

In urban and suburban installations the ability to mount a wind turbine in an elevated position is important, the main reasons being to avoid obstacles to air flow and also air turbulence. Turbulence is the fluctuation of wind speed and direction due to eddies and other circulation of wind caused by friction with the ground surface and obstacles. The presences of homes, sheds, fencing, trees and the like acts as obstacles and create turbulence which act to decrease the amount of energy that may be extracted by a turbine.

In assessing a site for power generation potential, turbulence is a key parameter that is typically rigorously measured. Mathematically, turbulence intensity in wind for a given time interval is defined as the standard deviation divided by the mean. If the turbulence is low, then air flow is smoother and greater efficiencies more likely.

It is dogma in the art that to minimise turbulence for an obstacle of height h, a turbine must be mounted at a height of at least 2h.

While an important component of wind power generation systems, turbine towers present a number of problems. Firstly, there is a significant cost involved in the fabrication and installation of the tower. In Australia, the tower must be certified to meet Australian Standards for wind loading, AS1170 Structural design actions. The tower must also be manufactured to a good standard with special attention given to strength of welds and quality of materials.

Even with the required standards, towers have the potential to become corroded or otherwise weakened by mechanical stresses. A collapse is possible where appropriate checking and maintenance is not carried out

Towers also create difficulties in accessing the turbine. From time to time turbines require maintenance of moving parts, and may occasionally break down requiring repair. Scaling the tower to effect any maintenance or repair requires specially trained personnel, and there is always the danger accidents.

There are aesthetic problems created by towers. The elevated position of the turbine affords for high visibility in the surrounding environments, with the tower itself also being highly visible. There are also noise problems created by towers and blade wind turbines. The trailing edge of the blade produces substantial vibration and noise which is highly audible, causing a reduced amenity of neighbouring homes.

Towers also present regulatory and legal problems. Erection of large structures typically requires planning approval from a local council. This may be a costly process, and may also be ultimately futile if approval is not forthcoming. Moreover, many properties have covenants on the Title restricting any overt modifications to the premises or land.

In the absence of a tower, it is often simply uneconomical to install a wind turbine. The presence of obstacles and associated turbulences may result in the amount of power generated being insufficient to justify the installation costs.

It is a further problem of micro scale wind power generation systems that power outputs may be less than that required by the user, or may render an installation economically unfeasible. While the design of turbines is constantly being improved, much kinetic energy from wind is lost in the power generation process.

It is an aspect of the present invention to overcome or alleviate a problem of the prior art to provide wind turbine installations that may be installed without a tower, while still providing acceptable power outputs. It is a further aspect to provide an alternative to prior art systems and methods for generating power from wind sources.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Unless the contrary intention is expressed, the features presented as preferred or alternative forms of the invention may be present in any of the inventions disclosed as alone or in any combination with each other.

In a first aspect, the present invention provides a system for generating electrical energy, the system comprising: a wind turbine, the wind turbine mounted in a position proximal to one or more structures, wherein the mounting position is such that the one or more structures act to channel wind toward the turbine.

In one embodiment of the system the one or more structures are selected independently from the group consisting of a building or a part thereof, a fence, and a gate.

In one embodiment of the system one of the one or more structures is an existing structure.

In one embodiment of the system one of the one of more structures is dedicated to channel wind.

In one embodiment of the system the building is a house.

In one embodiment of the system the part of the building is selected independently from the group consisting of an external wall surface, an eave, and an external roof surface.

In one embodiment of the system the turbine is mounted within the roof space of a pitched roof of a building, or within an enclosure disposed external to and on the pitched roof of a building.

In one embodiment of the system the turbine is mounted within the roof space, an external surface of the roof is fitted with a wind entry port.

In one embodiment of the system the wind turbine is mounted in a position proximal to two or more structures such that the two or more structures form a means for channelling wind toward the turbine.

In one embodiment of the system two of the two or more structures are independently selected from the group consisting of an external wall of a first building, an external wall of a second building, and a fence.

In one embodiment of the system the turbine comprises substantially elongate blades mounted about a central longitudinal axis.

In one embodiment of the system the turbine comprises at least 4, 5, 6, 7, 8, 9 or 10 blades.

In one embodiment of the system the turbine comprises blades the same or similar to those of a cylinder fan.

In one embodiment, the turbine comprises one or more curved baffle(s) or shroud(s) configured to retain the wind pressure on or about the blades for period of time greater than that achievable where no baffle or shroud is present.

In a second aspect the present invention provides a method for generating electrical energy, the system comprising: providing a wind turbine, mounting the turbine in a position proximal to one or more structures, wherein the mounting position is such that the one or more structures act to channel wind toward the turbine, and allowing wind to rotate the turbine.

In one embodiment of the method the one or more structures are selected independently from the group consisting of a building or a part thereof, a fence, a gate.

In one embodiment of the method one of the one or more structures is an existing structure.

In one embodiment of the method, the method comprises the step of mounting one of more structures proximal to the turbine to channel wind toward the turbine.

In one embodiment of the method the building is a house.

In one embodiment of the method the part of the building is selected independently from the group consisting of an external wall surface, an eave, and an external roof surface.

In one embodiment of the method, the method comprises the step of mounting the turbine within the roof space of a pitched roof of a building, or within an enclosure disposed external to and on the pitched roof of a building.

In one embodiment of the method the turbine is mounted within the roof space, the method comprises the step of fitting to an external surface of the roof a wind entry port.

In one embodiment of the method the method comprises the step of mounting the wind turbine in a position proximal to two or more structures such that the two or more structures form a means for channelling wind toward the turbine.

In one embodiment of the method two of the two or more structures are independently selected from the group consisting of an external wall of a first building, an external wall of a second building, and a fence.

In one embodiment of the method the turbine comprises substantially elongate blades mounted about a central longitudinal axis.

In one embodiment of the method the turbine comprises at least 4, 5, 6, 7, 8, 9 or 10 blades.

In one embodiment of the method the turbine comprises blades in an arrangement the same or similar to the blades of a cylinder fan.

In a third aspect, the present invention provides a kit of parts comprising a wind turbine, an enclosure adapted to be disposed on an external surface of a roof and enclose the turbine or a part of the turbine while allowing access of the turbine to wind.

In a fourth aspect the present invention provides a kit of parts comprising a wind turbine, a mounting adapted to secure the wind turbine within a roof space, a wind entry port, and optionally ducting to convey wind from the wind entry port to the turbine.

In one embodiment, either of the kit of parts may comprise instructions to construct a system as described herein, or instructions to generate electrical energy as described herein.

### BRIEF DESCRIPTION OF THE DRAWINGS

FIG. 1 is a diagrammatic view (lateral) of a turbine mounted at the apex of a roof, and within an enclosure.

FIG. 2 is a diagrammatic view (lateral) of a turbine mounted in a roof space.

FIG. 3 is a diagrammatic view (plan) of a turbine disposed between a house and a shed.

FIG. 4 is a diagrammatic view (plan) of a turbine disposed between a house and a fence.

FIG. 5 is a perspective drawing of a turbine rotor useful in the present invention.

FIG. 6 is a diagrammatic view of a turbine disposed on the roof of a house, and having air deflectors.

FIG. 7 is a diagram of the blades of a rotor (axial view) showing force vectors on each blade.

FIG. 8 shows the graphical results of a computer model of an embodiment of the invention showing rotation and power output as a function of wind velocity.

FIG. 9 is a wind velocity map resulting from a computer model of an embodiment of the invention.

### DETAILED DESCRIPTION OF THE INVENTION

The present invention is predicated at least in part on Applicant's finding that structures about a property such as buildings, fencing and like may be utilised to harness the power of wind in the generation of electricity. Accordingly, in a first aspect the present invention provides a system for generating electrical energy, the system comprising: a wind turbine, the wind turbine mounted in a position proximal to one or more structures, wherein the mounting position is such that the one or more structures act to channel wind toward the turbine.

The present invention is a significant departure from prior art systems and methods for the utilization of wind energy. Existing systems and methods direct the skilled person to maintain wind turbines away from structures, typically by the positioning of turbines in open areas and/or atop a tower of some description. By contrast, the present invention requires that the turbine is positioned proximal to structures which have hitherto been avoided given the desire to minimise air turbulence about the turbine, or the blockage of air currents by the structures.

Applicant has recognised that while structure(s) about a property may be deleterious to the harvesting of wind power, the same structure(s) can be utilized positively to capture wind. Useful amounts of electricity may be generated so long as the turbine is positioned appropriately such that the structure(s) act to channel wind toward the turbine. Accordingly, as used herein the term “proximal” is intended to mean that the turbine is positioned a distance from the structure(s) such that a negative effect of the structures on the harvesting of wind power is at least partially overcome.

In one embodiment, the wind turbine is disposed less than about 10, 9, 8, 7, 6, 5, 4, 3, 2 or 1 metres from the most proximal point of the most proximate structure. The distances are generally significantly shorter than systems and methods of the prior art. In particular, a tower may be used in prior art systems and methods to maintain a distance of at least 20 or 30 metres between the turbine and the nearest structure.

An advantage of some embodiments may be that wind power can be harvested on properties otherwise contraindicated (or at least rendered unfavourable or uneconomical) due to the presence of buildings, fencing and other structures. This is often the case in urban and suburban areas where dwellings are constructed at high density, and typically with fencing surrounding each property such that a turbine disposed in a back yard, for example, would be subjected to low levels of wind and/or turbulent wind.

Given the absence of significant free space at ground level in urban and suburban areas, turbines are frequently installed at height above the ground by use of a tower. Reference is made to the Background section herein detailing the many problems of towers. Thus, a further advantage of the present invention is that a tower is not necessary,

It will be appreciated that the positioning of the turbine with respect to the structure(s) may be guided by an analysis of typical air current flows about the structure(s). Such analysis may reveal that while proximity with regard to absolute distance is important other considerations such as spatial disposition of the turbine (in two or three dimensions) with regard to the structure(s) may also be important.

Other parameters that may affect the positioning of the turbine relative to the structure(s) is the appropriateness of the mounting point of the turbine. Considerations include the most typical wind direction and velocity in the area, exposure of the turbine to the weather, local council regulations, laws, safety, aesthetics and the like.

The skilled person will appreciate that the optimal positioning of a turbine with respect to the structure(s) may require an assessment of the velocity and direction of air currents about the structure(s). Surveys may be taken at set times over a period of time in order to gain a basic view of wind conditions. Devices such as anemometers are well known to the skilled person and can be positioned in positions of potentially suitability for the turbine location. By routine experimentation only, it will be possible to identify a suitable position by comparing velocities (and optionally direction) at a number of locations to determine a useful location.

The one or more structures which may used to channel wind toward a turbine may be a building (whether or not a dwelling) or a part of a building, or a fence, or a gate.

The building may be any of those found in a domestic situation such as a house, shed, a garage, a cabana and the like. Also included are commercial buildings such as an office block, a warehouse, a workshop, a factory, a sporting complex, a shop, a restaurant, an educational institution and the like.

Advantageously, the one or more structure(s) is/are existing structure(s). Existing structures are preferred so as to minimise cost, or adverse effects on aesthetics, or the requirement for planning permission et cetera.

In one embodiment, at least one of the one or more structures may be a structure dedicated to channelling wind toward the turbine. In some instances a channel for wind may not be formed (or may not be sufficiently well formed) by existing structures, and so dedicated structures may be used in the system. For example, where a channel formed by existing structures is too wide to channel air at sufficient velocity a dedicated structure may be disposed more proximal to one of the existing structures so as to narrow the channel and increase velocity.

Similarly, dedicated structures may be added to an adequately narrow channel so as to direct a greater volume of air through the channel thereby increasing velocity. For example, a flared structure may be used to collect and funnel a greater volume of air through the channel.

In other circumstances there may be no channel whatsoever formed by existing structures and a dedicated structure is included to form a channel. For example, an external side of house may be disposed distal from any other structure, and a dedicated structure (such as an elongate panel) may be placed parallel to the house side so as to form a channel.

As mentioned supra, the efficient generation of wind power on an urban or suburban parcel of land creates particular problems. Accordingly, in one embodiment the building is a house of the type normally constructed for residential purposes. Domestic dwellings (typically on relatively limited land) have been hitherto considered especially problematic in the context of power generation from wind. Homes generally take up the majority area of a suburban parcel of land, thereby limiting an open area from which wind energy may be collected. The present invention has overcome or alleviated this problem by utilizing a house per se in the collection of wind power.

Some parts of buildings have been found to be particularly useful in channelling wind toward a turbine. Such building parts include external wall surfaces, and external roof surfaces.

For houses (and indeed other buildings) Applicant proposes that the external surfaces are well suited to capturing wind. Air currents impacting the side of a house are forced to deflect and travel along the external surface and toward the edge of the house. Thus, a turbine may be disposed toward the edge of the external wall of a house to extract energy from wind that would be otherwise lost. Many existing types of wind turbine are not suited to the collection of wind in this matter, and so some in embodiments of the present systems a cylinder-type turbine is utilised. Turbines useful in the present invention are discussed further infra.

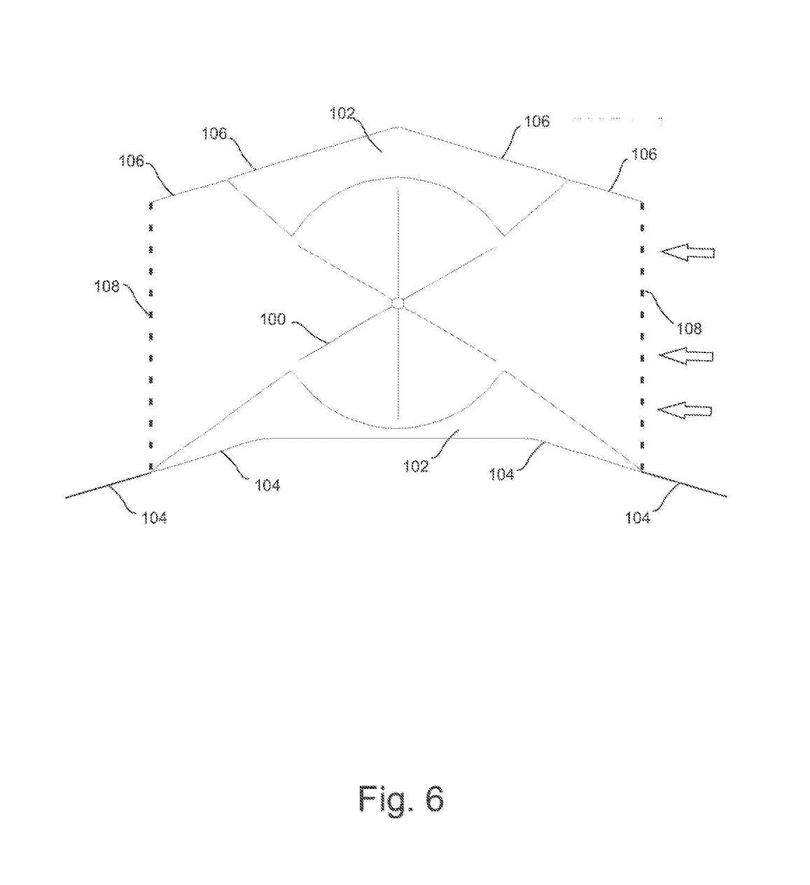

The eaves (also known as soffits), may be used as a collection point for wind travelling upwards and along an external wall of a house. Reference is made to FIG. 6B in that regard.

While the present systems may find utility when installed on or about any type of roof, in some embodiments, the system is adapted to extract energy from wind impacting the pitched roof of a building. Thus, the wind travels upwardly along the surface of the pitched roof and toward the apex where a turbine may be disposed to harvest the energy.

Alternatively, the roof may comprise a wind inlet port within the roofline, to capture wind as it travels along the surface of the pitched roof. Advantageously, a baffle may be disposed above the wind inlet port to prevent wind from flowing past the port. The baffle provides a concentrating effect and an area of increased air pressure may be established about the inlet port thereby increasing air velocity into the port. This may have the effect of spinning the turbine more rapidly thereby generating more power.

It will be appreciated that the wind inlet ports of the present systems may be disposed on or about non-roof parts of a structure such as a wall, a chimney (or any other venting means), or a portico.

As will be appreciated, while wind may be channelled by the broad surfaces of a building a difficulty arises in that the wind presents at the edge of the surface as a very wide but shallow current. Such currents are not efficiently collected by standard wind turbines (such as propeller-type turbines) and so in some embodiments particular turbine types are used as discussed in further detail infra.

Wind impacting the side of a building may be naturally directed to an overlying pitched roof. Thus, there is an additive effect provided such that wind impacting on both the wall and roof is captured.

In some embodiments, wind travelling upward an external wall and toward the roof may be captured in a wind entry port disposed in an eave or similar structure. Where an existing structure such as an eave is not present on the house, functionally equivalent structures may be fitted to the walls or roof which act in a similar manner.

Where wind is captured in eaves (or other equivalent structure) the turbine may be mounted within the roof space. Typically, ducting means connects the eave (or equivalent) to the turbine in a manner limiting losses of wind to the turbine.

Where wind is captured more directly from wind impacting the external surface of pitched roof the turbine may mounted within the roof space, or within an enclosure disposed external to and on the roof.

Turbines disposed on the external surface of a pitched roof may be disposed with an enclosure. For example, where the turbine is disposed at the apex of a pitched roof, the enclosure may straddle the apex and may extend along the apex for the enter length, or part length. The enclosure may comprise a wind entry port (and optionally a wind exit port) allowing wind to pass into (and optionally out of) the housing thereby turning the turbine and generating power

The enclosure may perform a protective function, ensuring the turbine avoids extremes of weather. A second function may be to channel air about the turbine to increase the rotation.

Turbines useful in the context of the present invention may include those having substantially elongate blades as shown in the accompanying Figures. These embodiments allow for the capture of wind energy from currents which are wide and shallow in dimension.

It is contemplated that higher efficiencies of power generation will be gained where the turbine is configured to prevent significant wind energy from passing through the turbine, and therefore remaining uncaptured. Prior art turbines such as propeller-type turbines allow for a high proportion of wind energy to continue past the blades. Such turbines typically have only three blades.

In contrast, Applicant proposes the use of turbines having substantially elongate blades and moreover a plurality of blades which may act to capture higher proportions of wind kinetic energy. Thus wind entering the turbine impacts the first blade, the first blade absorbing the kinetic energy and being moved in the same direction as the wind. This movement (which results in a rotation of the turbine) then present a second blade to the wind, which again absorbs further kinetic energy thereby rotating the turbine to present a third blade et cetera. It will be appreciated that by the continuous presentation of a new blade to the wind, little wind energy will be permitted to pass through the turbine without being captured and converted into angular kinetic energy (and ultimately electrical energy).

The turbine may have at least about 4, 5, 6, 7, 8, 9, 10, 15, 20, 25, 30, 35, 40, 45 or 50 blades.

In contrast to the present invention, conventional blade system wind generators rely on the wind to impact the blade and produce movement. The wind flows off the surface of the blade immediately, resulting in a reduced efficiency as the system fails to harvest maximum kinetic energy from the wind.

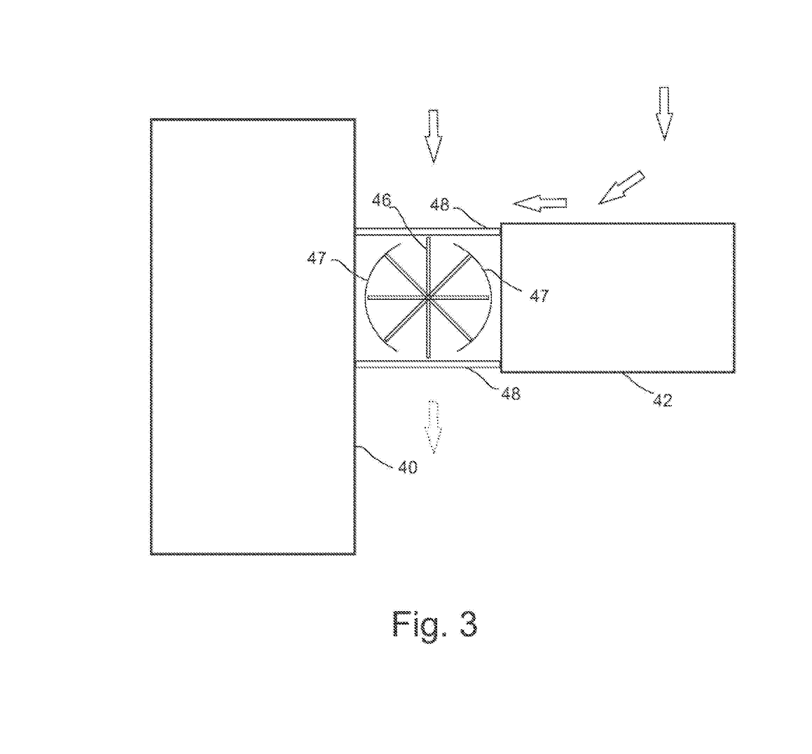

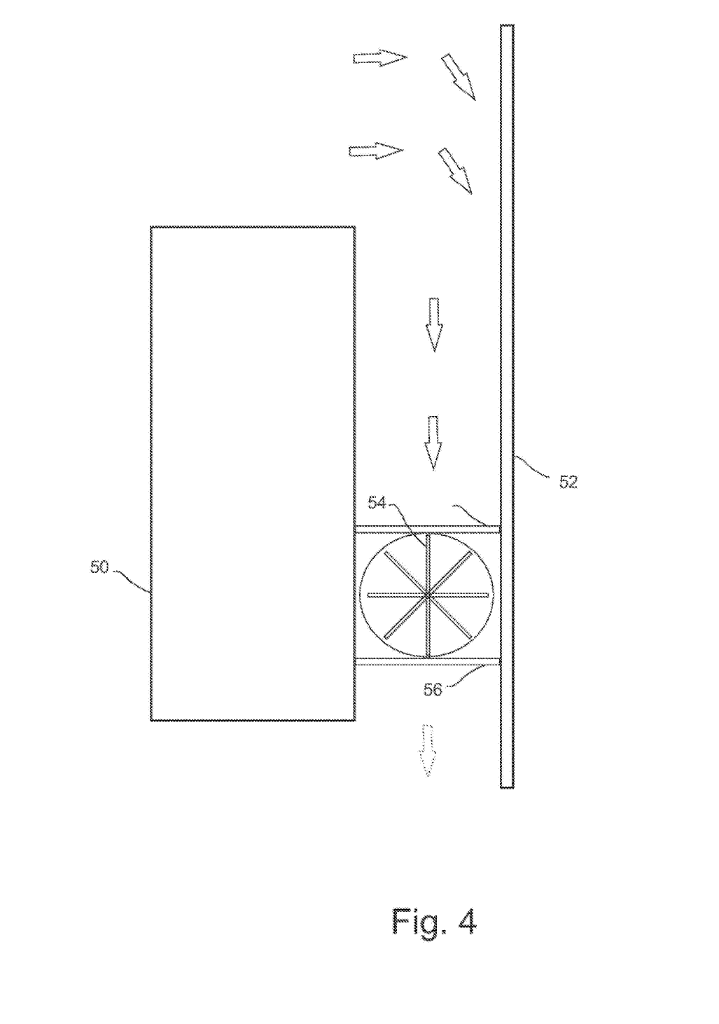

Accordingly, in one embodiment, the turbine comprises one or more curved baffle(s) or shroud(s) configured to retain the wind pressure on or about the blades for period of time greater than that achievable where no baffle or shroud is present. Typically, the baffle(s) or shroud(s) are mounted proximal to the circumference of rotation of the blades, as shown in FIGS. 3 and 4.

In these embodiments, the baffle(s) or shroud(s) do not continuously surround the turbine blades, and have at least a gap to allow entry of wind. A gap may also be provided to allow for the exit of wind.

Without wishing to be limited by theory in any way, these embodiments may allow a unit of wind energy to impart an greater angle of the rotation to the turbine, such that the following blade(s) is/are presented to the wind. This embodiment may decrease the amount of wind energy permitted to flow off the blade surface and pass through the turbine without being converted into angular kinetic energy (and ultimately electrical energy), thus dramatically increasing efficiency and maximizing the energy capture as far as possible.

Turbines suited to situations where wind is channelled between two structures may be mountable with the long axes of the blades being orthogonal to the ground. An example of this embodiment is shown in FIGS. 3 and 4.

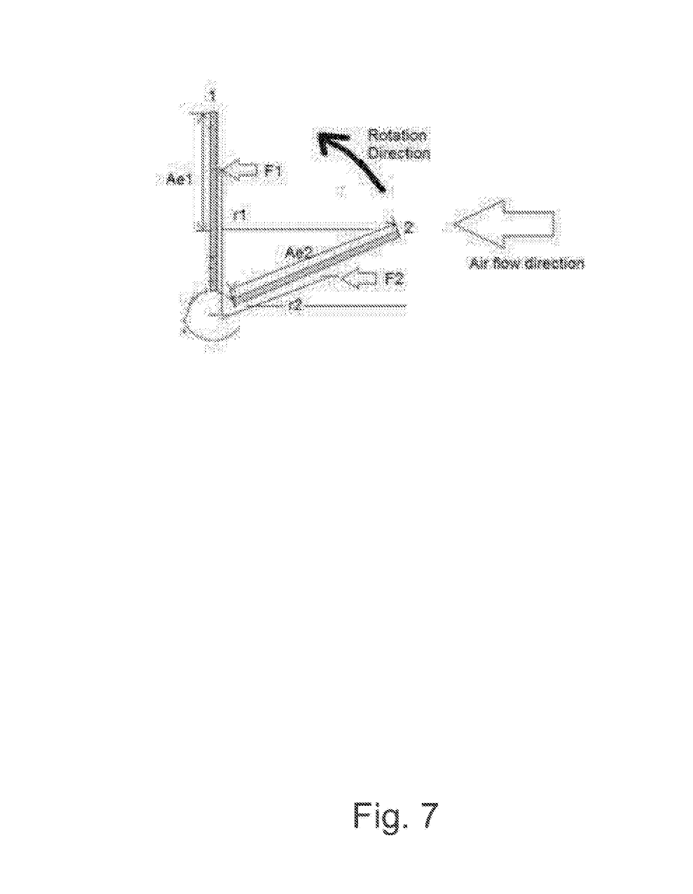

Turbines having a relatively high number of blades may be configured the same or similar to the blades in a cylinder fan, of the type commonly used in air handling. An exemplary form is shown in FIG. 7. Such contrivances are capable of extracting a high portion of kinetic energy from impacting wind,

The elongate blades may have a length to width ratio of at greater than about 1:3, 1:4, 15, 1:6, 1:7, 1:8, 1:9, 1:10, 1:15, 1:20, 1:25, 1:30, 1:35, 1:40, 1:45 or 1:50. The blades may be substantially planar, but in some embodiments are curved.

Turbines useful in the context of the present invention may be those capable of harvesting acceptable amounts of energy from air currents which are wide and narrow. Such turbines will find use in embodiments such as those configured to harness energy from wind impacting on broad surfaces discussed supra for wind impacting on pitched rooves and external walls.

A suitable turbine type for this embodiment may be a cylinder fan, or a series of cylinder fans disposed end-to-end. These fans are known to be useful in to convert electrical energy to wind energy (for example in air displacement applications such as air conditioners), however Applicant proposes utility in the reverse.

The system may be configured to collect wind and directed same toward the turbine rotor in a single duct. The ducts feed into the turbine housing which is configured to direct the incoming air currents about the blades in a manner to maximise the kinetic energy captured as far as possible. Alternatively the wind is collected from two entry ports (for example ports disposed within the soffits of a house), with ducting from the two entry ports being joined to feed a single duct, which in turn feeds the turbine.

These fans are known to be useful in to convert electrical energy to wind energy, however Applicant proposes utility in the reverse.

In some embodiments, the wind may be directed (for example by way of ducting, baffles, conduits and the like) such that wind impacts on only certain regions of the turbine. For example, the system may be configured such that incoming wind impacts only some blades of a turbine thereby ensuring the turbine rotates in a single direction. Blades may work optimally where wind impact only blades along one long edge of the cylinder.

Provided with the benefit of the present disclosure, other structures suitable for channelling wind toward and about the turbine will be apparent to the skilled artisan, with all such structures being included in the ambit of the present invention.

When used in a domestic situation, the present invention may emit sounds at an excessive level upon rotation of the turbine. This may be overcome or ameliorated by the use of sound absorbing materials disposed about or within the turbine housing, for example.

Another approach may to configure the turbine housing such that the inlet and outlet ports have extensions about the ports to create a shaft or tunnel-like effect. The walls of the shafts or tunnels may be lined with a sound absorbing material, or have a plurality of baffles disposed upon the inner wall(s) to deflect or absorb sound energy. The baffles may be dimensioned, angled or otherwise configured so as to interfere with the movement of air to a small extent so as to avoid any significant impact on airflow through the turbine.

The present systems may be utilised in a method for generating electricity at the micro scale. Accordingly, the present invention provides a method for generating electrical energy, the method comprising: providing a wind turbine, mounting the turbine in a position proximal to one or more structures, wherein the mounting position is such that the one or more structures act to channel wind toward the turbine, and allowing wind to rotate the turbine,

Preferably, the methods are useful for the generation of electricity at the micro level. The term “micro” in the context of the preset invention means a system capable of producing less than about 100 kW of electricity at maximum capacity.

Where the system is configured to be useful in a domestic or small business setting, the system may be capable of generating less than about 10 kW of electricity at maximum capacity per unit or assembly. In some embodiments, each unit or assembly generates between about 1 kW and about 5 kW of electricity.

It will be understood that wind power generation systems comprise a number of components, and that the present invention does not exclude a system that is less than complete. Complete systems may be manufactured using components obtained from separate sources and/or assembled by a number of separate parties. The skilled person is entirely familiar with various components of power generator systems such as generators, alternators, gearing systems, charging circuits, storage batteries, electricity distribution means such as wiring and cabling, transformers (step up and step down) and the like, and will be capable of constructing a complete system according to the present invention based on the disclosure of this specification and the common general knowledge in the art.

Given the benefit of the present disclosure the skilled person is amply enabled to obtain the required hardware parts and to install those parts as required. The installed parts may be then be exposed to wind in order to generate electricity. The generated electricity may be stored (in storage batteries, for example), consumed immediately, or fed into an electricity grid for use by others connected to the grid.

A complete system will comprise a generator. Two types of current are produced by electrical generators, either alternating current (AC) or direct current (DC). In the case of AC a voltage cycles sinusoidally with time, from positive peak value to negative. Because the voltage changes its sign the resulting current also continually reverses direction in a cyclic pattern. DC current flows in a single direction as the result of a steady voltage. DC is not usually used in modern power installations except for very low-powered systems of a few hundred watts or less.

Alternating voltage may be produced in a stationery coil or armature by a rotating magnetic field but more usually a coil is rotated in a stationary magnetic field. The magnetic field may be produced either by a permanent magnet or by another coil (i.e an electro-magnet) known as a field coil which is fed by direct current known as the excitation current. A generator supplying alternative current is described as an alternator to distinguish it from a machine designed to supply DC current which is known as a DC generator or dynamo.

Current flow when a voltage difference is place across a conducting body. In AC circuits the magnitude and timing of the current cycle relative to the voltage cycle will depend on whether the conductivity body is resistance, inductive, capacitive or some combination of these elements.

It is contemplated that the present systems can be retrofitted to existing buildings and arrangements of structures, or indeed incorporated into the construction of a building.

Fitting of components of the present systems will be facilitated by the provision of a kit of parts. The kit may comprise any or all of the components required for installation including a turbine, mounting hardware, an enclosure, a wind entry port, ducting, metal sheeting, timber components, fasteners and the like.

Optionally, the kit is comprised in packaging to form a vendible product. The kit may include instructions for use of the kit components, the instructions being embodied in any suitable form including text, video, audio, or graphical. The instructions may be printed directly onto any component of the kit, or any associated packaging. Instructions may be presented on a discrete pamphlet, user manual, online presentation system, in electronic form (such as portable document format, text file, or DVD).

The invention may be said broadly to consist in the parts, elements and features referred to or indicated in the specification of the application, individually or collectively, in any or all combinations of two or more of said parts, elements or features. Wherein the foregoing description reference has been made to integers or components having known equivalents thereof, those integers are herein incorporated as if individually set forth.

The present invention will now be more fully described by reference to preferred embodiments.

### DESCRIPTION OF PREFERRED EMBODIMENTS

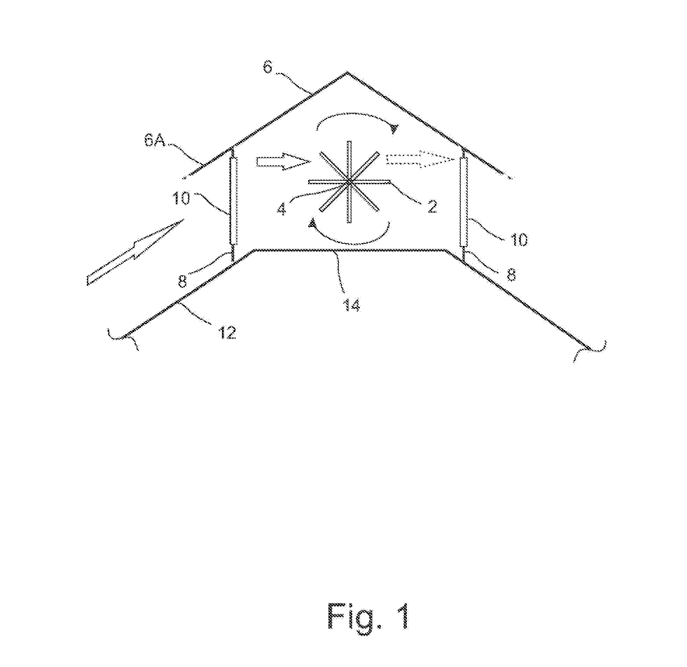

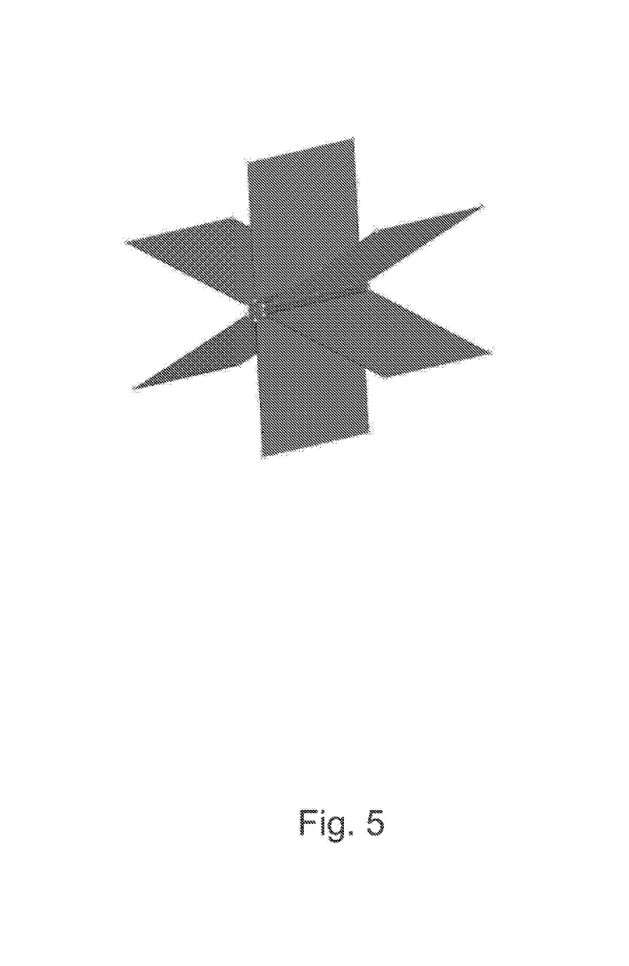

FIG. 1 shows a turbine installed atop the roof of a house. The turbine is shown end on, and is comprised of 8 rectangular blades 2 mounted on a longitudinal axle 4, and is similar to that shown at FIGS. 5A and 5B. The turbine is disposed with a housing having a roof 6 (and a roof extension 6A) and side walls 8. Contained within the side walls 8 are gratings 10 to allow the passage of air, but exclude debris, birds, insects and the like. The housing with turbine sits atop the roofline 12 and at the apex 14.

The solid outlined arrows show the flow of wind along the surface of the roof and into the housing. The roof extension 6A acts as a baffle to prevent wind from flowing past the grating 10, and away from the turbine.

Once inside the housing the wind spins the blades 2 of the turbine, with the axle 4 driving a generator unit (not shown).

The arrow having a discontinuous outline indicated air which has passed aver the turbine and exists the housing. It will be appreciated that air exiting will be at a lower velocity than that entering given the kinetic energy transferred to the blades 2.

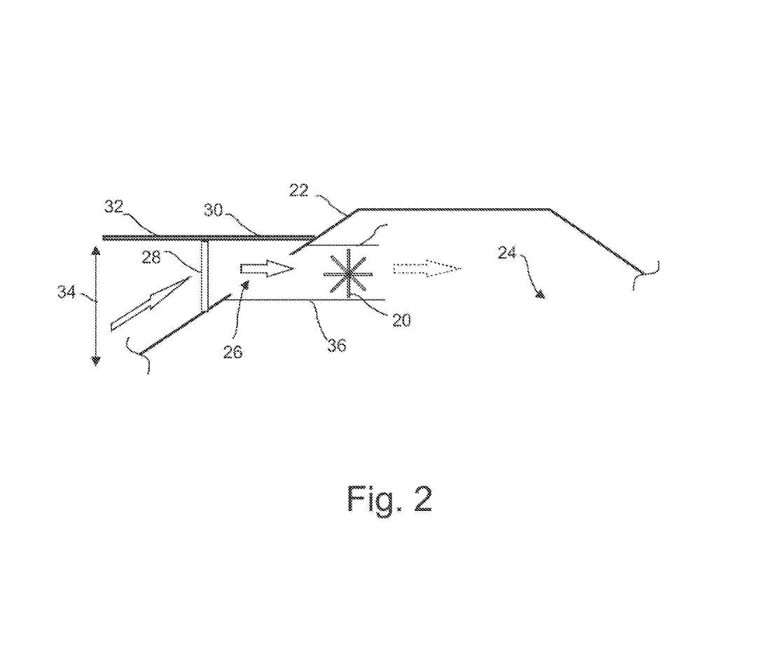

FIG. 2 shows an embodiment whereby the turbine 20 is disposed under the roofline 22 and within the roof space 24. The roofline 22 includes an opening 26 which is shielded by a grating 28. A flat roof 30 disposed over the opening 26 and grating 28 provides two functions: firstly to prevent ingress of water into the roof space 24, and secondly as a baffle. The roof extension 32 acts to prevent air from flowing past the grating 28, and also acts to funnel and therefore increase air velocity and pressure about the grating 28. The differential heights of air bodies at the edge of the roof extension 32 (shown by the double headed arrow 34) and the grating 28, and the movement of the air body from a larger volume to a smaller volume naturally increases velocity and pressure to more efficiently drive the turbine 20. Ducting 36 acts to contain the air about the turbine 36.

FIG. 3 shows an embodiment reliant on two buildings, a house 40 and an adjacent shed 42 to channel air into a turbine blades 46. The blades 46 are surrounded by two shrouds 47 which act to maintain wind pressure about the blades 46. The turbine 46 is protected by two gratings 48.

It will be seen from FIG. 3 that air is channelled toward the turbine 46 by the house 40 and shed 42. The surface areas of the house 40 and shed 42 are large, and can capture a significant amount of wind impacting on those surfaces.

FIG. 4 shows an embodiment reliant on two structures, a house 50 and an adjacent fence 52 to channel air into turbine blades 54. The blades 54 are surrounded by two shrouds 57 The turbine 54 is protected by two gratings 56.

It will be seen from FIG. 4 that air is channelled toward the turbine 54 by the house 50 and fence 52. The surface areas of the house 50 and fence 52 are large, and can capture a significant amount of wind impacting on those surfaces.

A preferred arrangement of turbine blades is shown at FIG. 5. The blades are mounted about a central longitudinal axis. Several such arrangements may be mechanically linked to turn a single generator

Computational Modelling

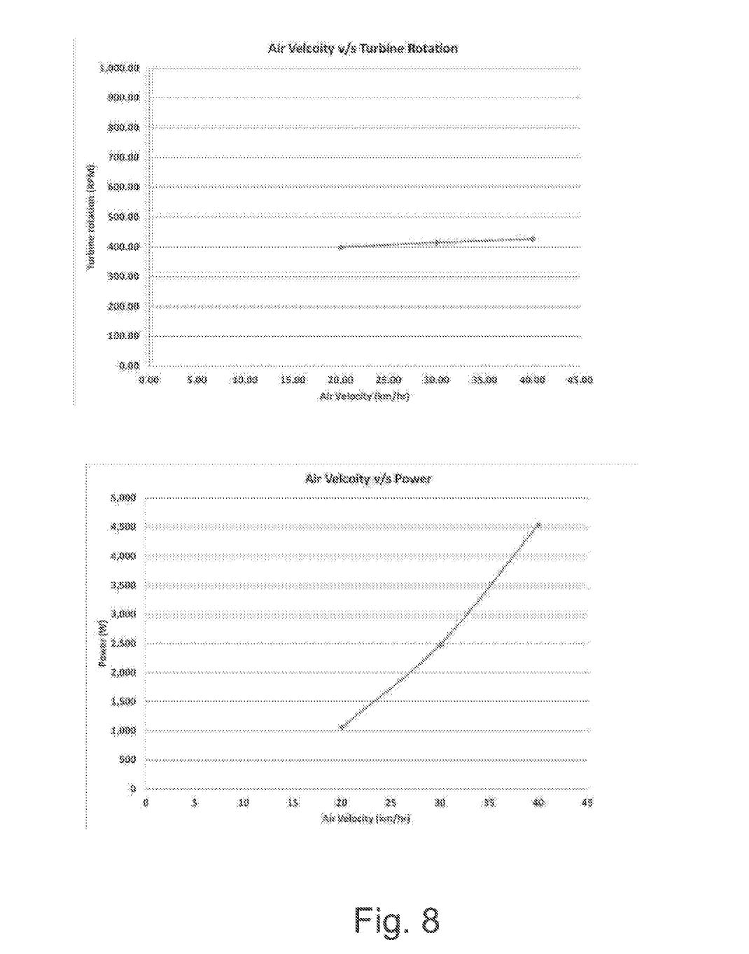

Modelling to identify power generation was performed on the embodiment shown in FIG. 8. This embodiment comprises a turbine rotor of diameter 600 mm having 6 blades 100, each blade of 0.75 mm thickness. The axial length of the turbine rotor was 1200 mm. Air deflectors 102 were disposed above and below the turbine rotor. The deflectors 102 extend the axial length of the turbine rotor to at least partially encase the rotor. The deflectors 102 have a curved inner face portion that shrouds the rotor blades. Disposed to either side of the curved inner face portion are ramp portions that act to funnel air toward the inlet facing the wind.

The turbine had a roof 106 extending beyond the edge of the air deflectors 102. Protective grilles 108 were disposed laterally to the rotor. The turbine was disposed at the apex of a roof surface 104.

The turbine embodiment in FIG. 8 was considered to be a useful model to analyse the capture of kinetic energy from the wind as it travels over a roof surface (as indicated by the arrows in FIG. 8), and into a turbine disposed at the apex.

Power output of the turbine was modelled for input wind velocities of 20 km/hr, 30 km/hr, and 40 km/hr. The assumption was made that the grilles 108 provide no resistance to airflow.

Calculation methodology:

1. Energy Calculations

$$1. Kinetic energy of air at inlet = {KE}_{In} = \frac{m {V}_{In}^{2}}{2}$$

$$2. Kinetic energy of air at outlet = {KE}_{Out} = \frac{m {V}_{Out}^{2}}{2}$$

$$3. Loss in Kinetic Energy = Energy to Overcome rotational resistance of shaft$$

$${KE}_{Rot} = {KE}_{In} - {KE}_{Out}$$

2. Angular Velocity Calculations

$$1. Rotational Kinetic Energy = {KE}_{Rot} \frac{l {ω}^{2}}{2} \text{?} the moment of inertia$$

$$2. Angular velocity = ω = \sqrt{\frac{2 {KE}_{Rot}}{I}}$$

$$3. Power = Torque \times Angular velocity = P = τ ω$$

$$4. Torque Calculations = Force \times distance$$

$$Power injected into the turbine by a torque is only instantaneous$$

$$\text{?} \text{indicates text missing or illegible when filed}$$

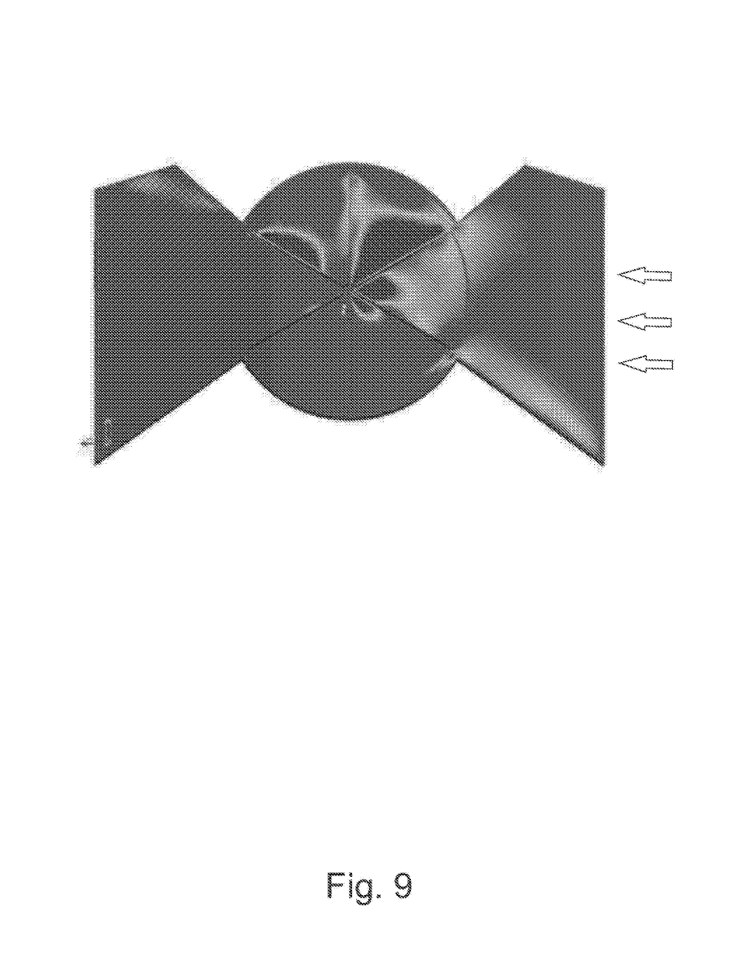

Reference is made to FIG. 9, a diagram showing the forces acting on blades 1 and 2, being F1 and F2 respectively. It will be noted that blade 1 is partially obscured by blade 2 such that blade 1 has a smaller effective surface area than blade 2. Force for each blade is calculated thus:

$$Force = \frac{Density \times {( Velcoity )}^{2} \times Area \times DragCoeff}{2}$$

A drag co-efficient of 1.5-2.0 was used.

The results of the simulation are tabulated below:

| Air Velocity | RPM | Power (W) |
|---|---|---|
| 20 km/hr | 399.00 | 1,055.00 |
| 30 km/hr | 415.00 | 2,478.00 |
| 40 km/hr | 427.00 | 4,536.00 |

Graphical analysis of the tabulated data above is shown at FIG. 10. The upper panel shows the relationship between air velocity and turbine rotation (RPM_, with the lower panel air velocity and power output (in Watts)

It will be noted from the graphs that while rotation of the turbine rotor increases only marginally according to wind velocity, power output increases significantly.

FIG. 11 shows a map simulating air velocity contours along a plane normal to the turbine axis. As shown by the arrows, the wind was directed from the right. It will be seen that the upper and low air deflectors act to guide the air to provide a significant increase in air velocity between the blades.

1. A system for generating electrical energy, the system comprising:
a wind turbine, the wind turbine mounted in a position proximal to one or more structures,
wherein the mounting position is such that the one or more structures act to channel wind toward the turbine.

2. The system of claim 1 wherein the one or more structures are selected independently from the group consisting of a building or a part thereof, a fence, and a gate.

3. The system of claim 1 wherein the one or more structures comprises a house.

4. The system of claim 1 wherein the one or more structures comprises a part of a building selected independently from the group consisting of an external wall surface, an eave, and an external roof surface.

5. The system of claim 1 wherein the one or more structures comprises a building and the turbine is mounted a roof space of a pitched roof of the building, or within an enclosure disposed external to and on the pitched roof of the building.

6. The system of claim 5 wherein where the turbine is mounted within the roof space, and wherein an external surface of the roof is fitted with a wind entry port.

7. The system of claim 1 wherein the wind turbine is mounted in a position proximal to two or more structures such that the two or more structures channel wind toward the turbine.

8. The system of claim 1 wherein the turbine comprises one or more curved baffle(s) or shroud(s) configured to retain wind pressure on or about blades of the turbine for period of time greater than that achievable where no baffle or shroud is present.

9. A method for generating electrical energy, the method comprising:
providing a wind turbine,
mounting the turbine in a position proximal to one or more structures,
wherein the mounting position is such that the one or more structures act to channel wind toward the turbine, and allowing wind to rotate the turbine.

10. The method of claim 9 wherein the one or more structures are selected independently from the group consisting of a building or a part thereof, a fence, a gate.

11. The method of claim 9 comprising mounting the one or more structures proximal to the turbine to channel wind toward the turbine.

12. The method of claim 9 wherein the one or more structures comprises part of a building, which is selected independently from the group consisting of an external wall surface, an eave, and an external roof surface.

13. The method of claim 9 wherein the one or more structures comprises a building and the method comprises mounting the turbine within a roof space of a pitched roof of the building, or within an enclosure disposed external to and on the pitched roof of the building.

14. The method of claim 13 wherein where the turbine is mounted within the roof space, and the method comprises fitting to an external surface of the roof a wind entry port.

15. The method of claim 9 comprising mounting the wind turbine in a position proximal to two or more structures such that the two or more structures channel wind toward the turbine.

16. The method of claim 15 wherein two of the two or more structures are independently selected from the group consisting of an external wall of a first building, an external wall of a second building, and a fence.

17. (canceled)

18. (canceled)

19. (canceled)
